(19) United States
(12) Patent Application Publication
(10) Pub. No.: US 2026/0270836 A1
(43) Pub. Date: Sep. 10, 2026

(54) FINE-GRANULAR URSP ENTERPRISE SOLUTION

(71) Applicant: Telefonaktiebolaget LM Ericsson (publ), Stockholm (SE)

(72) Inventors: Jari Vikberg, Järna (SE); Jan Backman, Kärna (SE)

(21) Appl. No.: 19/162,941

(22) PCT Filed: Mar. 6, 2023
(86) PCT No.: PCT/SE2023/050197

§ 371 Date: Sep. 7, 2025

(51) Int. Cl. H04W 40/02

(52) U.S. Cl. CPC H04W 40/02

(57) ABSTRACT

Enabling granular control of application flows of an Enterprise application while providing User Equipment Route Selection Policy (URSP) traffic category mapping.

Application flows of the Enterprise application can then be mapped to enterprise connectivity services that can be mapped to respective Protocol Data Unit (PDU) sessions established with a Communication Service Provider (CSP). By providing Enterprise application identifiers and URSP traffic category information in the work profiles administered by the Enterprise Information Technology (IT) Administration, application flows can thus be prioritized or handled based on the determined Quality of Service (QOS) level of each application flow, and not on a per application-basis.

### TECHNICAL FIELD

The present disclosure relates granular control of application flows of an Enterprise application while providing User Equipment Route Selection Policy (URSP) traffic category mapping in a wireless communications system.

### BACKGROUND

### 5G Background

Standardization work has been ongoing in Next Generation Radio Access Network (NG-RAN) and Fifth Generation (5G) Core network (5GC) as new radio access and new packet core network since Third Generation Partnership Project (3GPP) Rel-15 (see 3GPP Technical Specification (TS) 23.501 and 23.502 for stage-2 descriptions). FIG. 1 shows a 5G System architecture using service-based representation (corresponds to FIG. 4.2.3-1 from TS 23.501 V18.0.0).

FIG. 2 shows the internal architecture for a gNB 202 i.e., referring to a base station supporting New Radio (NR) Radio Access Technology (RAT) in the RAN of FIG. 1 and is referred to as a NG-RAN in this case (see 3GPP TS 38.401 for stage-2 description of NG-RAN). FIG. 2 assumes that both Higher Layer Split (HLS) and Control Plane 204 and User Plane 206 split (CP-UP split) have been adopted within the gNB 202.

### QoS Principle in 5GS

Quality of Service (QoS) is managed in a 5G wireless network, i.e., in a 5G System (5GS) on a per QOS flow level from the Core Network (CN). The NG-RAN (i.e., gNB or ng-eNB) is responsible for setting up the radio bearers for QOS Flows, radio resource management, and enforcing QoS according to the QoS Flow Profile—over the radio interface in the downlink and over the transport network in the uplink. QOS Flows are identified by a QOS Flow ID (QFI). QOS Flows including a QoS Profile are set up between the User Plane Function (UPF) in the 5GC and the user equipment device (UE).

5GS has defined a new term called a Protocol Data Unit (PDU) session that is very similar to a PDN connection in the earlier mobile generations. One difference is that there is normally only a single N3/NG-U tunnel (a GTP-U tunnel) for each PDU session between the UPF and NG-RAN. This means that the mapping of different traffic/QoS flows to radio bearers is performed in the NG-RAN, for example a radio bearer can carry one or more QoS Flows. A QoS Flow is the finest granularity of QoS differentiation in a PDU session. Each QoS Flow is associated with QoS parameters that are used to enforce the correct traffic forwarding treatment. Each packet belongs to a QoS Flow and one PDU session can carry one or several QoS Flows.

The QoS Flow level QoS Parameters can be either non-dynamic or dynamic. The Non-dynamic case is very similar to the QoS Class Identifier (QCI) concept in Evolved Packet System (EPS) but is called as 5G QoS Identifier (5QI). The 5QI is a scalar that is a part of the 5G QoS parameters and it is used as a reference to standardized (i.e., pre-configured) 5G QoS characteristics that control QoS forwarding treatment for the QoS Flow (e.g., scheduling weights, admission thresholds, queue management thresholds, link layer protocol configuration, etc.), see TS 23.501 clause 5.7.2 and particularly clause 5.7.2.1. This means that the 5QI value as such is signaled from 5GC to NG-RAN and defines the main characteristics for the QoS Flow. The dynamic case is somewhat different as in this case actual 5G QOS characteristics are also signaled from 5GC to NG-RAN. These signaled characteristics may include Priority Level, Packet Delay Budget, Packet Error Rate, Delay Critical, Averaging Window and Maximum Data Burst Volume, see TS 23.501 clause 5.7.2.1 and particularly clause 5.7.3.

### Traffic Classification

Traffic classification is about how to map different applications and their corresponding application flows from a specific UE to different network resources (e.g., network slices, PDU sessions, QoS flows and Radio Bearers) in both uplink (UL) and downlink (DL). Such network resources may have separate 5G QoS parameters and characteristics associated to them. Network Initiated-Quality of Service (NI-QoS) and URSP are examples of traffic classification mechanisms with different control points. Traffic classification is an essential functionality for any QoS support in mobile networks. It is however important to understand that additional functionality is needed when networks are planned and deployed with QoS support in mind. Examples of additional functionality needed are Service Level Agreement (SLA) and SLA assurance support. Most applications use multiple application flows with different requirements. This put demands on a mechanism to map individual application flows to the different network resources. In many cases, mapping at application-level will not be enough. An example of traffic classification, such as URSP, is depicted in FIG. 3, where a UE 302 communicates with an application provider 306 via a communication service provider (CSP) 304. The UE 302 may have one or more applications 308 that have different QOS flows 310-1, 310-2, 310-3 that have respective QoS levels.

### Solutions for URSP Traffic Categories

Traffic categories are needed to communicate QoS needs in a simple and generic way such as low latency and different levels of bandwidth requirements. Traffic categorization is therefore a variant of the traffic classification discussed above, i.e., all applications and application flows indicating the same traffic category would be classified to the same network resources.

URSP is standardized by 3GPP for a UE connected to multiple slices and/or PDU Sessions. The 3GPP standards define multiple different types of traffic descriptors such as DNN, domain, IP and application descriptors that would in principle allow both application and application flow level mapping to network resources (see 3GPP TS 23.503 chapter 6.6.2). Some device Operating System (OS) vendors have taken their own initiative on interpreting the App-ID field (i.e., the “Application descriptors” in table 6.6.2.1-2 of 3GPP TS 23.503) in the URSP rules. Instead of identifying an application, as actually defined in 3GPP TS 23.503, they put in a traffic category that the application could specify when setting up the communication. These traffic categories were not controlled by the operator, instead the operator is supposed to define a matching subscription and map to this with the aid of the traffic categories. Examples of such traffic categories are “Low Latency” and “High Bandwidth. 3 GPP Rel-18 contains work to standardize the traffic categories as part of Connection Capabilities (as defined in table 6.6.2.1-2 of 3GPP TS 23.503). Amongst others, this activity contains the classes “On demand downlink streaming” (mapping well to “High Bandwidth”), “Real time interactive traffic” (mapping well to “Reliability”) and “Critical communications” (that maps well to “Low Latency”). The following steps are illustrated in FIG. 4:
1. URSP rules are sent to the UE 402 (i.e., UE modem 404) from the Policy Control Function (PCF) 414 in the core network 416.
   a) As an example the URSP rules contain the following 3 rules:
      Default/Best Effort: when no other rules match, pointing to the DNN Selection field in the Route Selection component with the value: “Internet PDU Session, best effort”
      Low Latency: URSP Traffic Category “LOW LATENCY”, pointing to the DNN Selection field in the Route Selection component with the value: “Internet PDU Session, low latency”
      Background: URSP Traffic Category “BACKGROUND”, pointing to the DNN Selection field in the Route Selection component with the value: “Internet PDU Session, background”
2. URSP rules are read into the URSP rule cache 406 in the Operating System (OS) 410 of the UE 402.
3. App Client-X 408 is requesting a socket and indicates also a specific Traffic Category.
   a) As an example, the indicated Traffic Category is “LOW LATENCY”.
4. OS 410 parses the URSP rules in the URSP rule cache 406.
5. OS 410 requests the modem to create the relevant PDU session for the requested Traffic Category based on the parsed URSP rules(if needed i.e., when that PDU Session is not already established).
   a) Note that in FIGS. 4, 3 different PDU sessions (412) are already shown as established.
   b) As an example, the relevant PDU session is “Internet PDU Session, low latency” 412-2.
6. The socket requested by App Client-X 408 is bound to the source IP for the PDU Session associated with the requested Traffic Category and the socket is ready for use.

### An Exemplary Existing Ursp Enterprise Solution

URSP solution for enterprises is based on URSP Traffic Descriptors (TD) defined as NET_CAPABILITY_ENTERPRISE/2/3/4/5 and being part of the SLA between the Enterprise and the Communication Service Provider (CSP) for each connectivity service. These (for example up to) 5 connectivity services can be seen as different subscription levels and each Enterprise may be using one or more of these for their enterprise users, and actually different ones for different enterprise users as well. The SLA also includes some level of QoS, and the CSP controls how the PDU Session (e.g., QCI/5QI for the default bearer) and network slices are configured in the CSP network. The main difference to the consumer case is that the Enterprise Information Technology (IT) Admin controls how different enterprise applications are mapped to the connectivity services controlled by the CSP as enterprise policies. This functionality is part of e.g., the enterprise device management. The basic thinking for the enterprise policies is: An enterprise application is identified by an Enterprise application identifier (App-ID) and mapped to a specific User Equipment Route Selection Policy (URSP) TD, e.g., NET_CAPABILITY_ENTERPRISE3 (as an example and based on the SLA with the CSP). FIG. 5 illustrates an example of a URSP Enterprise solution.

The following steps take place in FIG. 5:
1. The Enterprise IT Admin 514 buys different connectivity services/subscription levels from one or more CSPs (e.g., 506). Each level is associated with an SLA related to a specific level of QoS and one of URSP TD “NET_CAPABILITY_ENTERPRISE/2/3/4/5”
   a. As part of this step, the CSP 506 ensures that the relevant URSP rules 508 are sent to the relevant Enterprise users' UEs 502.
2. The Enterprise IT Admin 514 is in full control of “Enterprise App-Store” and the Work Profile 504 part of each enterprise user device 502.
   a. The Enterprise IT Admin 514 configures the mapping of Enterprise applications towards the CSP connectivity levels i.e., “Enterprise App-ID→one of {NET_CAPABILITY_ENTERPRISE/2/3/4/5}”. One example is “Enterprise App-ID of a specific Enterprise application→NET_CAPABILITY_ENTERPRISE3”.
   b. The Work profile 504 is downloaded to the relevant Enterprise user devices 502.
3. When an Enterprise application 503 is started, it can be uniquely identified with its Enterprise App-ID, and the Work profile 504 is used to map the Enterprise Application to a specific URSP TD. In this example the mapping is to URSP TD “NET_CAPABILITY_ENTERPRISE3”.
   a. The “NET_CAPABILITY_ENTERPRISE3” is used as the main input to URSP rules 508 received from the CSP 506.
   b. The modem 510 is requested to create the relevant PDU session 518 for “NET CAPABILITY_ENTERPRISE3” i.e., as defined in the URSP rules 508 (if needed i.e., when that PDU Session is not already established).
4. The Enterprise Application is active and all application flows for the enterprise application are mapped to the PDU Session 518 for “NET_CAPABILITY_ENTERPRISE3” to the application provider 516 i.e., as defined in the URSP rules.

The current Enterprise URSP solution described above enables the Enterprise IT Admin 514 to define how Enterprise applications are mapped to the connectivity services (i.e., network slices and PDU sessions) from one or more CSPs 506. The current solution is however on Enterprise application level i.e., all application/traffic flows from a specific Enterprise application are treated in the same way. Most applications use multiple application flows with different requirements. One example is a conferencing software (i.e., an application) with different application flows for signaling, payload for voice, payload for video, payload for messaging and software (SW) updates. Typically, voice, video, messaging and SW updates require different QoS. This put demands on a mechanism to map individual application flows to the different network resources, i.e., to different network slices and PDU sessions related to the CSP provided connectivity services. In many cases, mapping at application-level will not be enough. The main problem to be solved is to introduce a more fine-granular traffic classification solution in the Enterprise URSP solution.

### SUMMARY

The present disclosure provides for enabling granular control of application flows of an Enterprise application while providing User Equipment Route Selection Policy (URSP) traffic category mapping. Application flows of the Enterprise application can then be mapped to enterprise connectivity services that can be mapped to respective Protocol Data Unit (PDU) sessions established with a Communication Service Provider (CSP). By providing Enterprise application identifiers and URSP traffic category information in the work profiles administered by the Enterprise Information Technology (IT) Administration, application flows can thus be prioritized or handled based on the determined Quality of Service (QOS) level of each application flow, and not on a per application-basis.

In an embodiment, the present disclosure includes a method performed by a User Equipment (UE) for enabling granular control of application flows of an enterprise application with URSP traffic classification. The method can include receiving URSP rules that map enterprise connectivity services to respective PDU sessions. The method can also include receiving a network connection setup request associated with the enterprise application, wherein the network connection setup request comprises an indicator of a traffic category. The method can also include determining an enterprise connectivity service based on the traffic category and an enterprise profile associated with the enterprise application. The method can also include transmitting data from the enterprise application via a PDU session that is selected based on the enterprise connectivity service and the URSP rules.

In an embodiment, a UE can be configured for enabling granular control of application flows of an enterprise application with URSP traffic classification. The UE can include a radio interface and processing circuitry configured to receive URSP rules that map enterprise connectivity services to respective PDU sessions. The processing circuitry can also be configured to receive a network connection setup request associated with the enterprise application, wherein the network connection setup request comprises an indicator of a traffic category. The processing circuitry can also be configured to determine an enterprise connectivity service based on the traffic category and an enterprise profile associated with the enterprise application. The processing circuitry can also be configured to transmit data from the enterprise application via a PDU session that is selected based on the enterprise connectivity service and the URSP rules.

In an embodiment, a non-transitory computer-readable medium comprising instructions stored thereon, that when implemented by a processor perform operations for enabling granular control of application flows of an enterprise application with URSP traffic classification. The operations can include receiving URSP rules that map enterprise connectivity services to respective PDU sessions. The operations can also include receiving a network connection setup request associated with the enterprise application, wherein the network connection setup request comprises an indicator of a traffic category. The operations can also include determining an enterprise connectivity service based on the traffic category and an enterprise profile associated with the enterprise application. The operations can also include transmitting data from the enterprise application via a PDU session that is selected based on the enterprise connectivity service and the URSP rules.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a Fifth Generation (5G) system architecture;

FIG. 2 illustrates an example of a Next Generation Radio Access Network (NG-RAN) architecture;

FIG. 3 illustrates an example of traffic classification;

FIG. 4 illustrates an example of User Equipment Route Selection Policy (URSP) traffic categorization;

FIG. 5 illustrates an example of a URSP Enterprise solution;

FIG. 6 illustrates an example of an enhanced USRP Enterprise solution that enables granular control of application flows of an Enterprise application according to some embodiments of the present disclosure;

FIG. 7 illustrates a message sequence chart for an enhanced USRP Enterprise solution that enables granular control of application flows of an Enterprise application according to some embodiments of the present disclosure;

FIG. 8 illustrates one example of a cellular communications system according to some embodiments of the present disclosure;

FIG. 9 is a schematic block diagram of a User Equipment device (UE) according to some embodiments of the present disclosure; and

FIG. 10 is a schematic block diagram of the UE of FIG. 9 according to some other embodiments of the present disclosure.

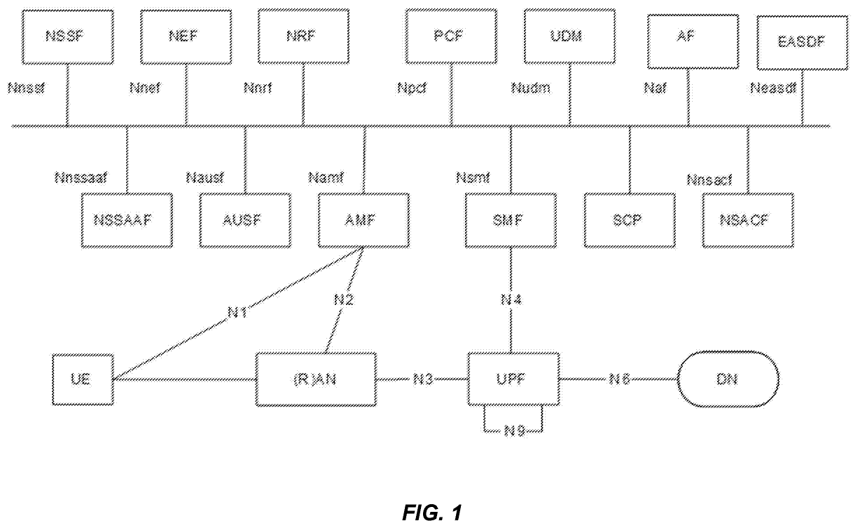

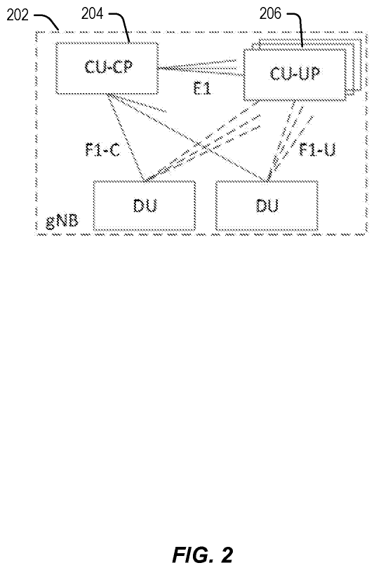

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

The present disclosure provides for enabling granular control of application flows of an Enterprise application while providing User Equipment Route Selection Policy (URSP) traffic category mapping. Application flows of the Enterprise application can then be mapped to enterprise connectivity services that can be mapped to respective Protocol Data Unit (PDU) sessions established with a Communication Service Provider (CSP). By providing Enterprise application identifiers and URSP traffic category information in the work profiles administered by the Enterprise Information Technology (IT) Administration, application flows can thus be prioritized or handled based on the determined Quality of Service/Quality of Experience (QoS/QoE) levels of each application flow, and not on a per application-basis.

Some of the advantages provided by the techniques disclosed herein is the possibility to enable more fine-granular control of how Enterprise applications, and application flows are mapped to the connectivity services provided by the CSPs. This can enable improved QoS/QoE for the enterprise users. In addition, it can also enable more fine-granular usage of the CSP connectivity services, e.g., by only using more expensive connectivity services only when really needed.

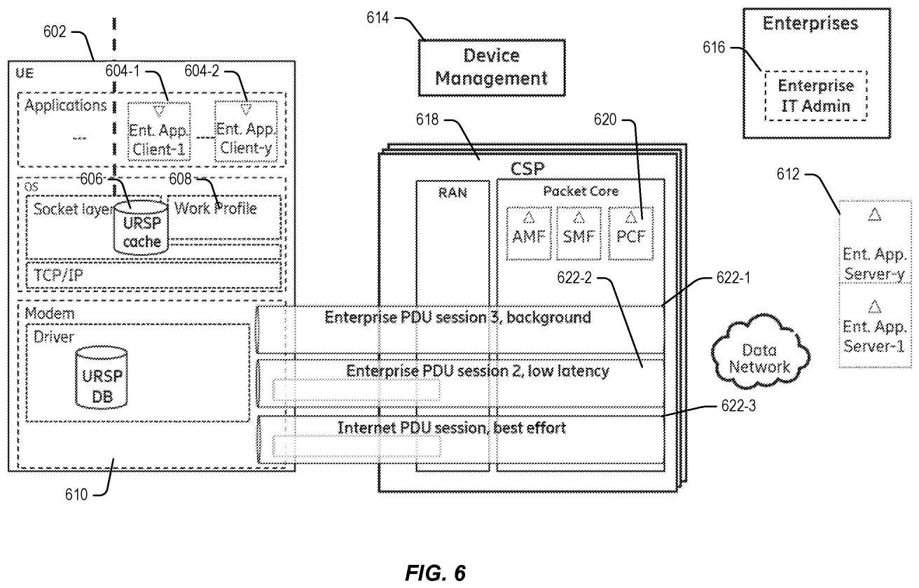

FIG. 6 illustrates an example of an enhanced USRP Enterprise solution that enables granular control of application flows of an Enterprise application according to some embodiments of the present disclosure.

The Enterprise IT Admin 616 triggers the establishment of the solution toward one or more CSPs 618. The Enterprise IT Admin 616 buys different connectivity service/subscription levels from a CSP 618 for example implemented as different network slices and/or PDU sessions. Each level is also associated with a Service Level Agreement (SLA) related to a specific level of QoS and e.g., the URSP Traffic Descriptor (TD) “NET_CAPABILITY_ENTERPRISE/2/3/4/5”. In this example, there are 2 enterprise connectivity services associated with “NET_CAPABILITY_ENTERPRISE2” and “NET_CAPABILITY_ENTERPRISE3” from one CSP 618. As part of this step, the CSP 618 ensures that the relevant URSP rules are sent to the relevant Enterprise users UEs (e.g., UE 602). URSP rules are sent to the modem 610 of the UE 602 from the PCF 620 of the core network of the CSP 618.

The relevant URSP rules are the ones associated with the 2 enterprise connectivity services (in this example) associated with an Enterprise Application 604. It is to be appreciated that there can be multiple Enterprise Applications, 604-1, 604-2, that can collectively or individually referred to as Enterprise Application 604. The important part is that a specific enterprise connectivity service is associated with a specific network resource in the URSP rules. For example, that “NET_CAPABILITY_ENTERPRISE2” enterprise connectivity service is associated with a PDU Session “Enterprise PDU session 2”. The actual coding of the enterprise connectivity service can be done in multiple ways, for example using the Application Descriptors TD with values Operating System (OS) Id=“ANDROID”, OS App Id type=“NET_CAPABILITY_ENTERPRISE2”), or by having a specific Connection Capability TD value (e.g., a numeric value) indicating “NET_CAPABILITY_ENTERPRISE2”). The coding of the PDU Session is in the DNN field i.e. DNN Selection field in the Route Selection components in the URSP rule. The DNN field is typically a string, e.g. “Enterprise PDU session 2”. The URSP rules are read into the OS URSP rule cache 606.

The Enterprise IT Admin 616 is in full control of “Enterprise App-Store” and the Work Profile 608 part of each enterprise user device 602. The Enterprise IT Admin 616 triggers the configuration of the Work Profiles 608 in the relevant enterprise UEs 602.

The Enterprise IT Admin 616 uses any Device management tool 614 and configures the work profile 608 with the mapping of Enterprise application flows towards the CSP connectivity levels i.e., “Enterprise App-ID and URSP Traffic Category” “→one of {NET_CAPABILITY_ENTERPRISE/2/3/4/5}”. In an embodiment, the mapping of the Enterprise application flows can be based on a combination of Enterprise application identifiers and URSP traffic categories. As an example, an enterprise application identifier can be static for a respective Enterprise application, but the same Enterprise application may have multiple application flows, each with different URSP traffic categories that may be mapped to different Enterprise connectivity services. One example is “Video Conferencing Enterprise App-ID and LOW_LATENCY”→NET_CAPABILITY_ENTERPRISE2”.

The Work profile 608 is then downloaded to the relevant Enterprise user devices 602.

An Enterprise Application Client 604 (i.e., application/software) is started and connectivity for a specific application flow is triggered. This step can be repeated for all the application flows to be requested by the Enterprise Application Client 604.

Enterprise App Client-1 604-1 can request a network connection (e.g., socket) and also indicates a specific Traffic Category. The indication of the Traffic Category may be implementation specific. In one example it could be a numeric socket option value associated with the request to create the socket. This request is towards the Work Profile 608 part of the Enterprise side on the UE. In one example, the started enterprise application is “Video Conferencing enterprise” and the indicated Traffic Category is “Low Latency”. The traffic categories can include, but not be limited to: a low latency traffic category; a background traffic category; a default traffic category; a high bandwidth traffic category; a medium bandwidth traffic category; a bounded medium latency traffic category; or a time-critical traffic category (very low latency).

The Work Profile 608 is parsed to see if there is a match for the combination of the Enterprise Application Identifier for the Enterprise Application Client 604 and the requested Traffic Category. The result of the parsing is a URSP TD to be used towards the URSP rules i.e., one of {NET_CAPABILITY_ENTERPRISE/2/3/4/5}. In one example, a rule is found in the Work profile 608 indicating that for the combination of “Video Conferencing Enterprise” Enterprise Application Identifier and Traffic Category “Low Latency” the URSP TD “NET_CAPABILITY_ENTERPRISE2” should be used towards the URSP rules.

The OS can then parse the URSP rules in the URSP rule cache 606 using the URSP TD identified above. In one example, the URSP TD “NET_CAPABILITY_ENTERPRISE2” is used for parsing the URSP rules. The parsing of the URSP rules leads to identification of the related PDU session in the DNN Selection field in the Route Selection component of the URSP rule. The DNN Selection field contains “Enterprise PDU session 2” 622-2.

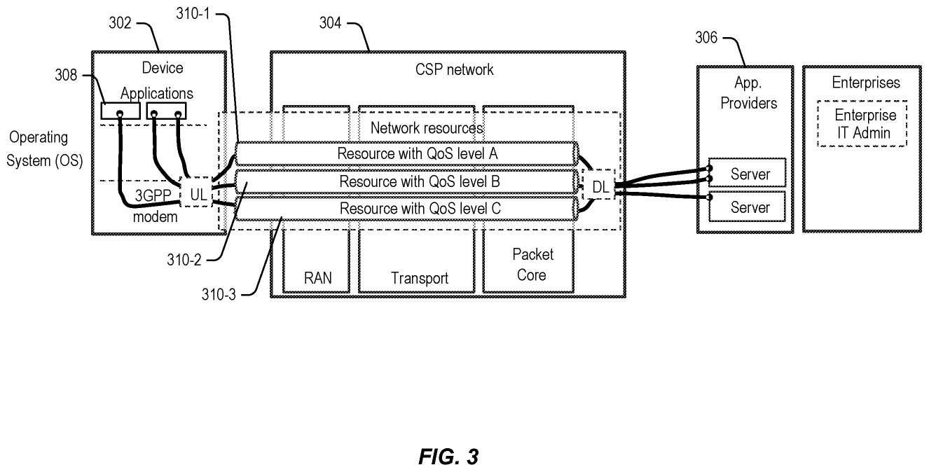

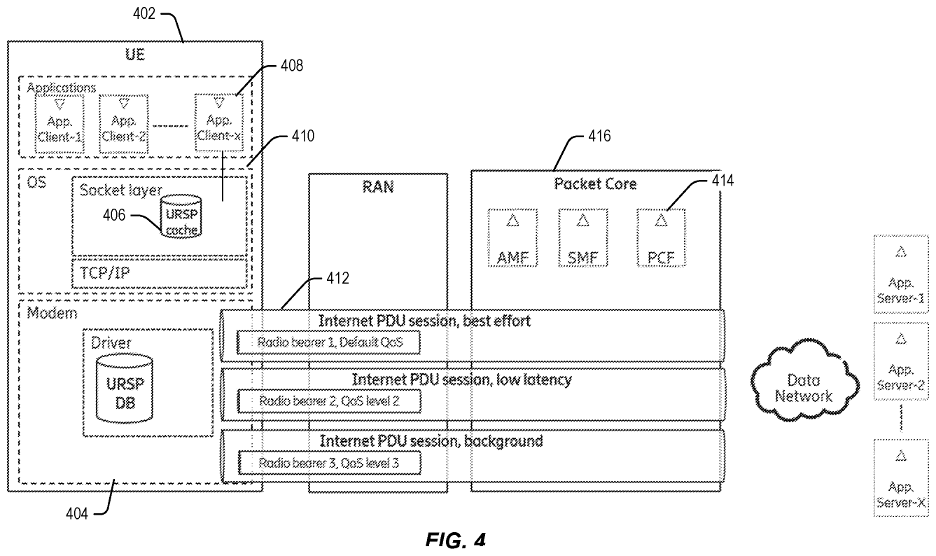

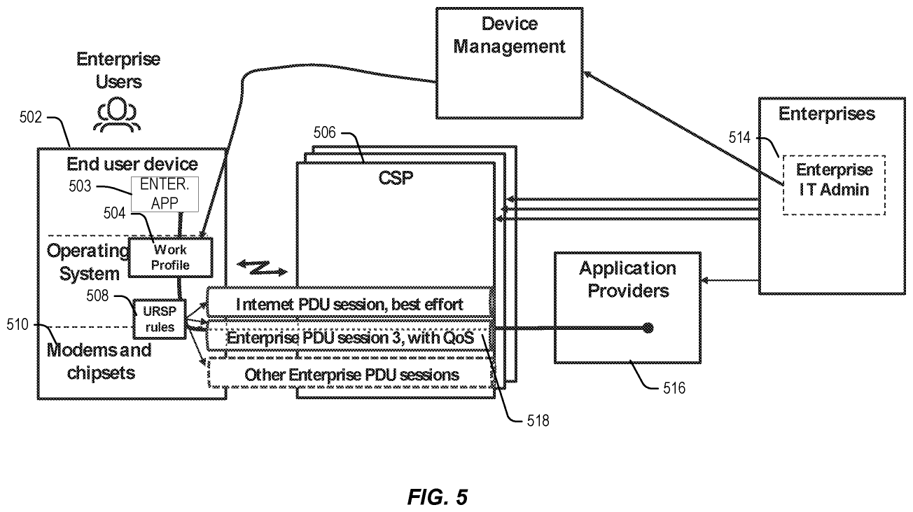

The OS can then request the modem 610 to create the relevant PDU session for the requested URSP TD (if needed i.e., when that PDU Session is not already established). The UE requested PDU Session establishment is defined in 3GPP TS 23.502 clause 4.3.2 and particularly clause 4.3.2.2. In one example, the relevant PDU session is “Enterprise PDU session 2” 622-2. Note that in FIGS. 6, 3 different PDU sessions (622-1, 622-2, and 622-3) are already shown as established. 2 of these are Enterprise related i.e., shown as Enterprise PDU sessions 2 622-2 and 3 622-1, while one of the PDU sessions is an Internet PDU 622-3.

The socket requested by Enterprise App Client-1 604-1 is bound to the source IP of the PDU Session associated with the requested URSP TD and the requested socket is ready for use.

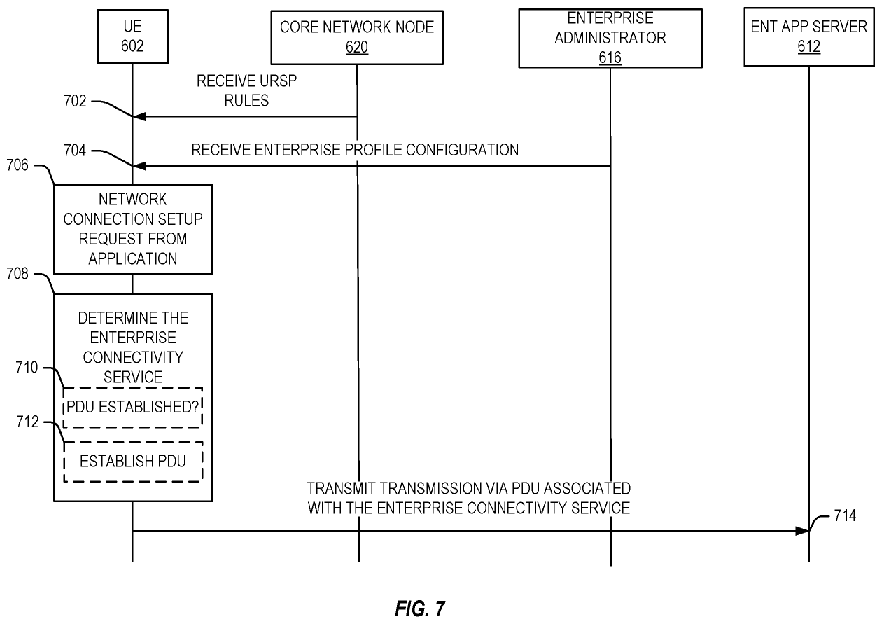

FIG. 7 illustrates a message sequence chart for an enhanced USRP Enterprise solution that enables granular control of application flows of an Enterprise application according to some embodiments of the present disclosure.

At 702, the UE 602 can receive the URSP rules from a core network node (e.g., the PCF 620). The URSP rules can map enterprise connectivity services to respective PDU sessions 622. In an embodiment, the URSP rules can be received by the modem 610 of the UE 602, and stored in the URSP cache 606. In an embodiment, a URSP rule of the URSP rules comprises a DNN selection field with an indicator of a PDU session 622.

At 704, the UE 602 can receive configuration of the enterprise profile from an enterprise IT administrator 616. The Enterprise IT Admin 616 can use any Device management tool 614 and configures the work profile 608 of the UE 602 with the mapping of Enterprise application flows towards the CSP connectivity levels i.e., “Enterprise App-ID and URSP Traffic Category” “→one of {NET_CAPABILITY_ENTERPRISE/2/3/4/5}”. One example is “Video Conferencing Enterprise App-ID and LOW_LATENCY”→NET_CAPABILITY_ENTERPRISE2.

At 706, the UE 602, or the OS of the UE 602 can receive a network connection setup request from an enterprise application 604. In an embodiment, the network connection setup request can include a socket request. The network connection setup connection request can also include an indicator for a specific Traffic Category. The indication of the Traffic Category may be implementation specific. In one example it could be a numeric socket option value associated with the request to create the socket. This request is towards the work profile 608 part of the Enterprise side on the UE 602 or to another entity either within the UE 602 or without that has access to the work profile. In one example, the started enterprise application is “Video Conferencing enterprise” and the indicated Traffic Category is “Low Latency”. In another embodiment, the indicator of the enterprise connectivity service is at least one of an Application Descriptors TD or a Connection Capability TD value.

At 708, the UE 602 can determine an enterprise connectivity service based on the traffic category and an enterprise profile (608) associated with the enterprise application (604). In an embodiment, the UE 602 can determine the enterprise connectivity service based on an enterprise application identifier and the indicator for the traffic category. For example, in one example, the Enterprise application can be a video conference application and be associated with an application identifier and a low latency traffic category.

At 710, the UE 602 can optionally determine whether the PDU session 622 associated with the enterprise connectivity service is established or not, and if it is not established, at 712, the UE 602 can establish the PDU session 622.

At 714, the UE 602 can transmit data from the enterprise application (604) via a PDU session 622 that is selected based on the enterprise connectivity service and the URSP rules. The data can be transmitted to the Enterprise Application server 612 via the CSP 618.

It is to be appreciated that the UE 602 can receive more than one network connection setup requests from the same enterprise application 604 and based on the associated enterprise connectivity service, transmit data from the same or other PDU sessions that have different QoS levels.

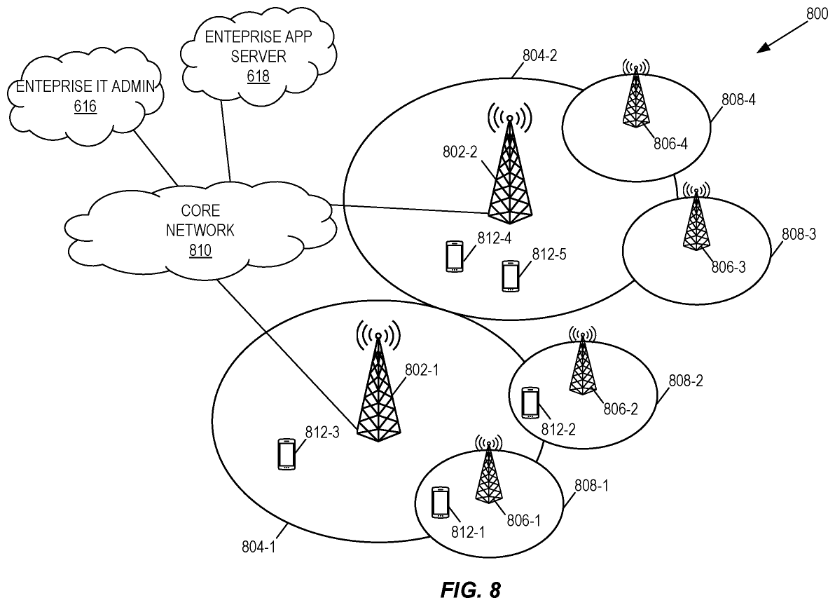

FIG. 8 illustrates one example of a cellular communications system 800 in which embodiments of the present disclosure may be implemented. In the embodiments described herein, the cellular communications system 800 can be a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 802-1 and 802-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 804-1 and 804-2. The base stations 802-1 and 802-2 are generally referred to herein collectively as base stations 802 and individually as base station 802. Likewise, the (macro) cells 804-1 and 804-2 are generally referred to herein collectively as (macro) cells 804 and individually as (macro) cell 804. The RAN may also include a number of low power nodes 806-1 through 806-4 controlling corresponding small cells 808-1 through 808-4. The low power nodes 806-1 through 806-4 can be small base stations (such as pico or femto base stations) or Remote Radio Heads (RRHs), or the like. Notably, while not illustrated, one or more of the small cells 808-1 through 808-4 may alternatively be provided by the base stations 802. The low power nodes 806-1 through 806-4 are generally referred to herein collectively as low power nodes 806 and individually as low power node 806. Likewise, the small cells 808-1 through 808-4 are generally referred to herein collectively as small cells 808 and individually as small cell 808. The cellular communications system 800 also includes a core network 810, which in the 5GS is referred to as the 5GC. The base stations 802 (and optionally the low power nodes 806) are connected to the core network 810. The core network 810 can include a PCF 620 that can provide URSP rules to the UE 812 as described above with reference to FIG. 6.

The base stations 802 and the low power nodes 806 provide service to UEs 812-1 through 812-5 in the corresponding cells 804 and 808. The UEs 812-1 through 812-5 are generally referred to herein collectively as UEs 812 and individually as UE 812. In the following description, the UEs 812 are oftentimes UEs, but the present disclosure is not limited thereto. The UEs 812 can send enterprise data via granularly controlled PDU sessions between the UEs 812 and the enterprise application server 612 via the core network 810 and the RAN. The Enterprise IT Admin 616 can also configure the work profiles 608 of the UEs 812.

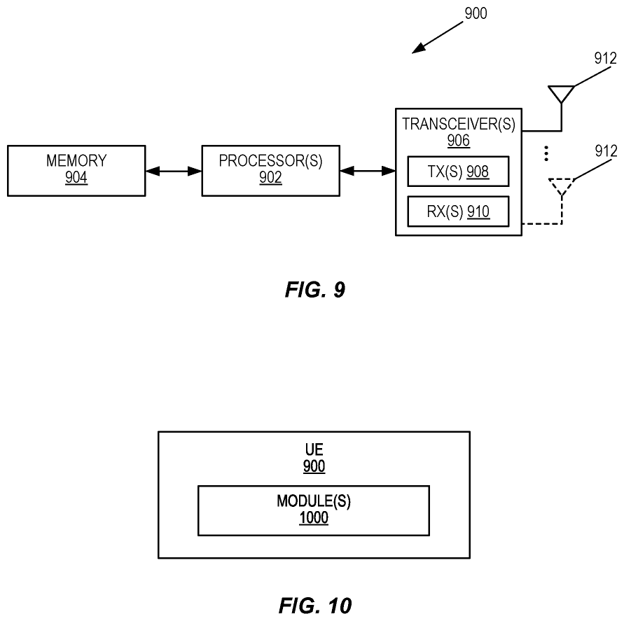

FIG. 9 is a schematic block diagram of a wireless communication device 900 according to some embodiments of the present disclosure. As illustrated, the wireless communication device 900 includes one or more processors 902 (e.g., Central Processing Units (CPUs), Application Specific Integrated Circuits (ASICs), Field Programmable Gate Arrays (FPGAs), and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by on of ordinary skill in the art. The processors 902 are also referred to herein as processing circuitry. The transceivers 906 are also referred to herein as radio circuitry. In some embodiments, the functionality of the wireless communication device 900 described above may be fully or partially implemented in software that is, e.g., stored in the memory 904 and executed by the processor(s) 902. Note that the wireless communication device 900 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the wireless communication device 900 and/or allowing output of information from the wireless communication device 900), a power supply (e.g., a battery and associated power circuitry), etc.

In an embodiment, UE 900 can be similar to and perform the functionality described with respect to UE 602 in FIGS. 6 and 7.

In some embodiments, a computer program including instructions which, when executed by at least one processor, causes the at least one processor to carry out the functionality of the wireless communication device 900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the wireless communication device 900 according to some other embodiments of the present disclosure. The wireless communication device 900 includes one or more modules 1000, each of which is implemented in software. The module(s) 1000 provide the functionality of the wireless communication device 900 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
5QI Fifth Generation Quality of Service Identifier
AF Application Function
AMF Access and Mobility Function
AN Access Network
ASIC Application Specific Integrated Circuit
AUSF Authentication Server Function
CN Core Network
CPU Central Processing Unit
CSP Communication Service Provider
DCI Downlink Control Information
DL Downlink
DN Data Network
DNN Data Network Name
DSP Digital Signal Processor
eNB Enhanced or Evolved Node B
EPC Evolved Packet Core
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IT Information Technology
IP Internet Protocol
LTE Long Term Evolution
MME Mobility Management Entity
NEF Network Exposure Function
NF Network Function
NI-QoS Network Initiated-Quality of Service
NR New Radio
NRF Network Function Repository Function
NSSF Network Slice Selection Function
OS Operating System
PCF Policy Control Function
PDU Protocol Data Unit
P-GW Packet Data Network Gateway
QCI Quality of Service Class Identifier
QUE Quality of Experience
QOS Quality of Service
RAM Random Access Memory
RAN Radio Access Network
ROM Read Only Memory
RRH Remote Radio Head
SCEF Service Capability Exposure Function
SLA Service Level Agreement
SMF Session Management Function
TD Traffic Descriptor
UDM Unified Data Management
UE User Equipment
UL Uplink
UPF User Plane Function
URSP User Equipment Route Selection Policy
VPN Virtual Private Network
WAN Wide Area Network

Those skilled in the art will recognize improvements and modifications to the embodiments of the present disclosure. All such improvements and modifications are considered within the scope of the concepts disclosed herein.

1. A method performed by a User Equipment (UE) for enabling granular control of application flows of an enterprise application (604) with UE Route Selection Policy (URSP) traffic classification, the method comprising:
receiving URSP rules that map enterprise connectivity services to respective Protocol Data Unit (PDU) sessions;
receiving a network connection setup request associated with the enterprise application, wherein the network connection setup request comprises an indicator of a traffic category;
determining an enterprise connectivity service based on the traffic category and an enterprise profile associated with the enterprise application; and
transmitting data from the enterprise application via a PDU session that is selected based on the enterprise connectivity service and the URSP rules.

2. The method of claim 1, further comprising:
determining that the PDU session is not established; and
establishing the PDU session.

3. (canceled)

4. The method of claim 3, wherein a URSP rule of the URSP rules comprises a Data Network Name (DNN) selection field with an indicator of the PDU session.

5. (canceled)

6. The method of claim 1, wherein the network connection setup request is a socket request.

7. (canceled)

8. The method of claim 6, further comprising:
receiving another network connection setup request from the enterprise application, the other network connection setup request comprising a different traffic category;
determining, another enterprise connectivity service associated with the enterprise application based on the other network connection setup request; and
transmitting other data from the enterprise application via another PDU session associated with the other enterprise connectivity service.

9. The method of claim 1, wherein the traffic category is at least one of a plurality of traffic categories comprising:
a low latency traffic category;
a background traffic category;
a default traffic category;
a high bandwidth traffic category;
a medium bandwidth traffic category;
a bounded medium latency traffic category; or
a time-critical traffic category.

10. The method of claim 1, wherein the socket request is bound to a source Internet Protocol (IP) address of the PDU session.

11. A User Equipment (UE) configured for enabling granular control of application flows of an enterprise application with UE Route Selection Policy (URSP) traffic classification, the UE comprising a radio interface and processing circuitry configured to:
receive URSP rules that map enterprise connectivity services to respective Protocol Data Unit (PDU) sessions;
receive a network connection setup request associated with the enterprise application, wherein the network connection setup request comprises an indicator of a traffic category;
determine an enterprise connectivity service based on the traffic category and an enterprise profile associated with the enterprise application; and
transmit data from the enterprise application via a PDU session that is selected based on the enterprise connectivity service and the URSP rules.

12. The UE of claim 11, wherein the processing circuitry is further configured to:
determine that the PDU session is not established; and
establish the PDU session.

13. (canceled)

14. The UE of claim 13, wherein a URSP rule of the URSP rules comprises a Data Network Name (DNN) selection field with an indicator of the PDU session.

15. (canceled)

16. The UE of claim 11, wherein the network connection setup request is a socket request.

17. (canceled)

18. The UE of claim 16, wherein the processing circuitry is further configured to:
receive another network connection setup request from the enterprise application, the other network connection setup request comprising a different traffic category;
determine, another enterprise connectivity service associated with the enterprise application based on the other network connection setup request; and
transmit other data from the enterprise application via another PDU session associated with the other enterprise connectivity service.

19. The UE of claim 11, wherein the traffic category is at least one of a plurality of traffic categories comprising:
a low latency traffic category;
a background traffic category;
a default traffic category;
a high bandwidth traffic category;
a medium bandwidth traffic category;
a bounded medium latency traffic category; or
a time-critical traffic category.

20. The UE of claim 11, wherein the socket request is bound to a source Internet Protocol (IP) address of the PDU session.

21. A non-transitory computer-readable medium comprising instructions stored thereon, that when implemented by a processor perform operations for enabling granular control of application flows of an enterprise application with User Equipment (UE) Route Selection Policy (URSP) traffic classification, the operations comprising:
receiving URSP rules that map enterprise connectivity services to respective Protocol Data Unit (PDU) sessions;
receiving a network connection setup request associated with the enterprise application, wherein the network connection setup request comprises an indicator of a traffic category;
determining an enterprise connectivity service based on the traffic category and an enterprise profile associated with the enterprise application; and
transmitting data from the enterprise application via a PDU session that is selected based on the enterprise connectivity service and the URSP rules.
